(19) United States
(12) Patent Application Publication
(10) Pub. No.: US 2016/0049065 A1
(43) Pub. Date: Feb. 18, 2016

(54) ELECTRONIC DETECTING MODULE AND ELECTRONIC DEVICE

(71) Applicant: ABILITY ENTERPRISE CO., LTD., New Taipei City (TW)

(72) Inventors: Jih-Yung LU, New Taipei City (TW); Cheng-Kuang TSENG, New Taipei City (TW); Yu-Cheng HUANG, New Taipei City (TW)

(73) Assignee: ABILITY ENTERPRISE CO., LTD., New Taipei City (TW)

(21) Appl. No.: 14/820,708

(22) Filed: Aug. 7, 2015

(30) Foreign Application Priority Data
Aug. 13, 2014 (TW) 103127735

(51) Int. Cl. G08B 21/18

(52) U.S. Cl. CPC G08B 21/18

(57) ABSTRACT

An electronic detecting module and an electronic device are provided. The electronic detecting module comprises a base, a sensor and a cover. The base has an accommodating recess. The sensor is disposed within the accommodating recess. The cover closes or opens the accommodating recess. The sensor comprises a substrate, a first electrode disposed and a second electrode, wherein the first electrode and the second electrode are disposed on the substrate with a potential difference.

This application claims the benefit of Taiwan application Serial No. 103127735, filed Aug. 13, 2014, the subject matter of which is incorporated herein by reference.

### BACKGROUND OF THE INVENTION

1. Field of the Invention

The invention relates in general to an electronic transmitting module and an electronic device, and more particularly to an electronic transmitting module capable of detecting abnormality and an electronic device.

2. Description of the Related Art

In general, once impurity, such as liquid, invades the interior of an electronic device, the impurity causes the electronic device to be damaged. Thus, the convention electronic device usually uses gasket to prevent the liquid from entering the interior of the electronic device.

However, when the gasket has aged or degraded, it is possible to make the liquid invade the interior of an electronic device. Under this situation, user can't be aware of the damage reason unless the user sends the electronic device back the store for repairing, such that the risk can't be reduced and the damage can't be remedied.

### SUMMARY OF THE INVENTION

The invention provides an electronic transmitting module and an electronic device.

According to an embodiment of the present invention, an electronic transmitting module is provided. The electronic transmitting module comprises a base, a sensor and a cover. The base has an accommodating recess. The sensor is disposed within the accommodating recess. The cover closes or opens the accommodating recess. The sensor comprises a substrate, a first electrode and a second electrode. The first electrode and the second electrode are formed on the substrate with a potential difference.

According to another embodiment of the present invention, an electronic transmitting module is provided. The electronic transmitting module comprises a base, a sensor and a circuit board. The sensor is disposed on the substrate and electrically connected to the circuit board. The sensor includes a substrate, a first electrode and a second electrode. The first electrode and the second electrode are formed on the substrate with a potential difference.

According to another embodiment of the present invention, an electronic device is provided. The electronic device includes an electronic transmitting module and a control unit. The electronic transmitting module comprises a base, a sensor and a cover. The base has an accommodating recess. The sensor is disposed within the accommodating recess of the base. The cover closes or opens the accommodating recess. The sensor comprises a substrate, a first electrode and a second electrode. The first electrode and the second electrode are formed on the substrate with a potential difference. The control unit starts a protection mode according to an abnormal signal from the sensor.

According to another embodiment of the present invention, an electronic device is provided. The electronic device includes an electronic transmitting module and a control unit. The electronic transmitting module comprises a base, a sensor and a cover. The sensor is disposed on the substrate and electrically connected to the circuit board. The sensor includes a substrate, a first electrode and a second electrode. The first electrode and the second electrode are formed on the substrate with a potential difference. The control unit starts a protection mode in accordance with an abnormal signal from the sensor.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a decomposed diagram of an electronic transmitting module according to an embodiment of the invention;

FIG. 1B shows a cross-sectional view of the electronic transmitting module;

FIG. 2 shows a top view of the sensor;

FIG. 3 shows a front view of the bonding layer;

FIG. 4 shows a top view of a sensor according to another embodiment of the invention;

FIG. 5 shows a top view of a sensor according to another embodiment of the invention;

FIG. 6 shows a top view of a sensor according to another embodiment of the invention; and

FIG. 7 shows a top view of a sensor according to another embodiment of the invention.

### DETAILED DESCRIPTION OF THE INVENTION

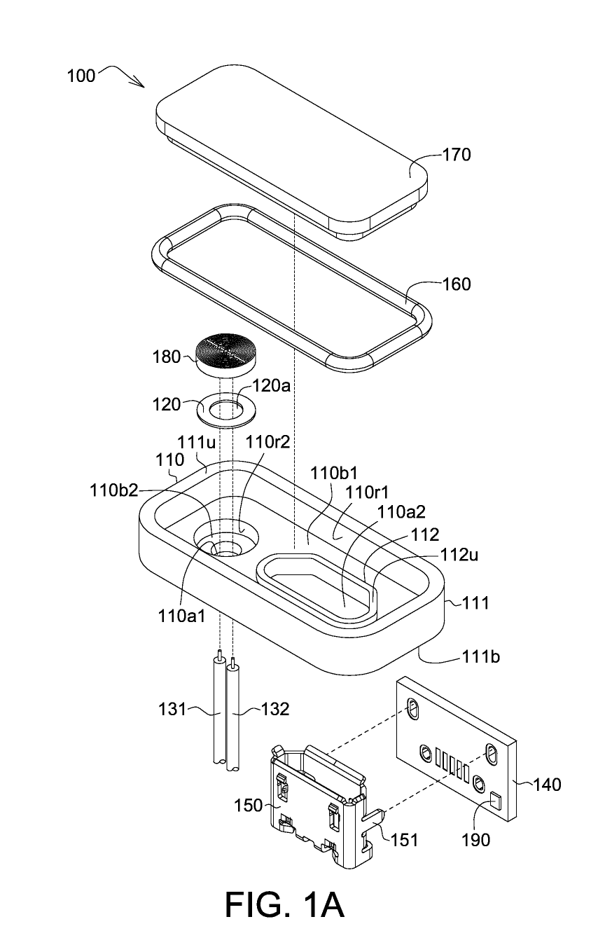

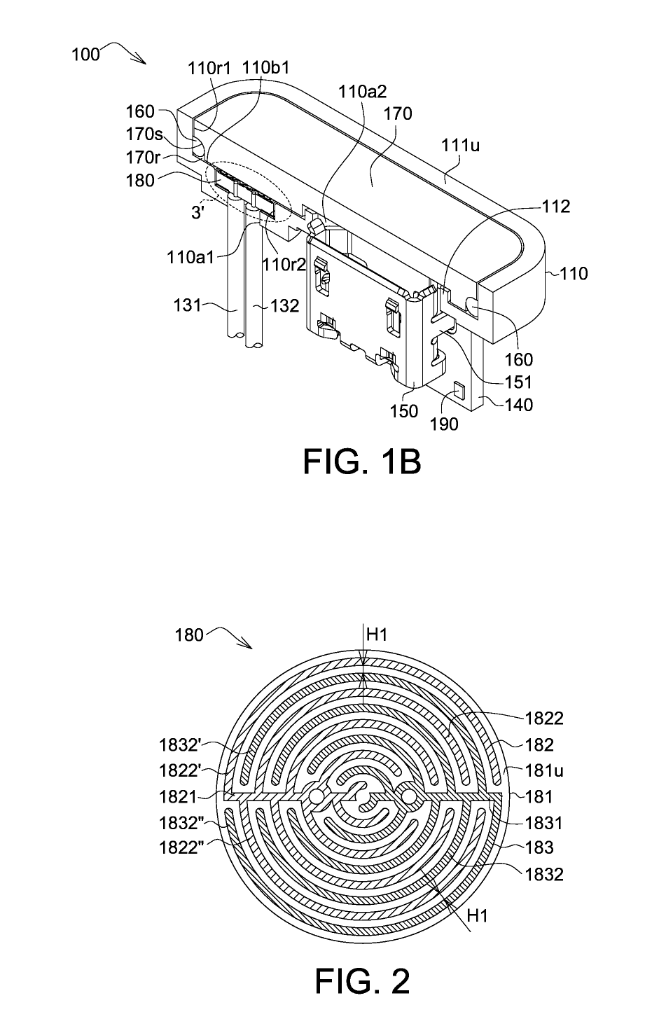

FIG. 1A shows a decomposed diagram of an electronic transmitting module 100 according to an embodiment of the invention, and FIG. 1B shows a cross-sectional view of the electronic transmitting module 100.

The electronic transmitting module 100 may be built in a device (not shown), serve as a part of the device or an accessory of the device, and an electrical signal may be transmitted between the electronic transmitting module 100 and an exterior. The electronic transmitting module 100 may be charging/discharging modules for a battery or an electrical signal transmitting port. In detail, the device includes, but not limiting to, a mobile communication device, a camera, a video camera, a tablet PC, a notebook, or other device which need to connect with an exterior device.

The electronic transmitting module 100 mainly includes a base 110, a bonding layer 120, a first conductive wire 131, a second conductive wire 132, a circuit board 140, a connector 150, a gasket 160, a cover 170, a sensor 180 and a control unit 190.

In another embodiment, the electronic transmitting module 100 may mainly comprise the base 100, the cover 170 and the sensor 180. In another embodiment, the electronic transmitting module 100 may mainly comprise the base 100, the circuit board 140 and the sensor 180. In the other embodiment, the electronic transmitting module 100 may mainly comprise the circuit board 140 and the sensor 180. However, the structure of the electronic transmitting module 100 of the present embodiment is not limited to FIGS. 1A and 1B.

The base 110 includes a main body 111, a block wall 112, a first accommodating recess 110r1, a second accommodating recess 110r2, a first through hole 110a1 and a second through hole 110a2. The main body 111 basically forms an accommodating space by the first accommodating recess 110r1. In detail, the first accommodating recess 110r1 extends from an upper surface 111u of the main body 111 toward a lower surface 111b of the main body 111, but does not pass through the main body 111. The second accommodating recess 110r2 extends from a bottom surface 110b1 of the first accommodating recess 110r1 toward the lower surface 111b, but does not pass through the main body 111. The first through hole 110a1 passes through the main body 111 from a bottom surface 110b2 of the second accommodating recess 110r2 to the lower surface 111b of the main body 110. The second through hole 110a2 passes through the main body 111 from an upper surface 112u of the block wall 112 to the lower surface 111b of the main body 110. The block wall 112 extends from the bottom surface 110b1 of the first accommodating recess 110r1 toward the upper surface 111u of the main body 111.

The bonding layer 120 may be disposed between the bottom surface 110b2 of the second accommodating recess 110r2 and the sensor 180. In an embodiment, the bonding layer 120 may be a tape, such as double sided tape.

The bonding layer 120 has a through hole 120a. One end (not shown) of the first conductive wire 131 passes through the first through hole 110a1 and the through hole 120a of the bonding layer 120 and connects to the sensor 180. The another end (not shown) of the first conductive wire 131 connects to the circuit board 140 to electrically connect the sensor 180 and the circuit board 140. Similarly, the second conductive wire 132 also passes through the first through hole 110a1 and the through hole 120a of the bonding layer 120 to electrically connect the sensor 180 and the circuit board 140.

The connector 150 includes a plurality of pins 151. The connector 150 may be fixed to the circuit board 140 by way of the pins 151 inserting into the circuit board 140. As shown in FIG. 1B, a part of the connector 150 may be accommodated within the second through hole 110a2 and the block wall 112. The connector 150 may be an USB (Universal Serial Bus), a HDMI (High Definition Multimedia Interface), a power port or other connector, such as a network connector, an audio connector or a video connector; however, such exemplification is not meant to be for limiting.

As shown in FIG. 1B, the gasket 160 may be disposed within the first accommodating recess 110r1 and along an edge of the bottom surface 110b1 of the first accommodating recess 110r1. When the cover 170 closes the first accommodating recess 110r1 of the base 110, the gasket 160 may be located within the a ring-shaped recess 170r of the cover 170, and an sidewall 170s of the ring-shaped recess 170r presses against the gasket 160, such that the gasket 160 tightly touches the sidewall 170s of the ring-shaped recess 170r. In detail, the cover 170 may directly connect to the base 110 by an end (not shown) or indirectly connect to the base 110 by a connecting part (not shown); alternatively, the cover 170 and the base 110 are independent and separated two elements, and user may selectively close or open the first accommodating recess 110r1 of the base 110. When the cover 170 closes the first accommodating recess 110r1, the first accommodating recess 110r1 may be sealed, such that exterior object is not easy to enter or drop into the base 110. When the cover 170 and the base 110 are detached, it is possible to make the connector 150 exposed, such that an exterior connector (not shown) may electrically connect to the connect 150 through the second through hole 110a2. In one embodiment, the gasket 160 may adopt a rubber.

As shown in FIG. 1B, the sensor 180 may be disposed within the second accommodating recess 110r2 of the base 110.

FIG. 2 shows a top view of the sensor 180. The sensor 180 includes a substrate 181, a first electrode 182 and a second electrode 183. The first electrode 182 and the second electrode 183 are formed on an upper surface 181u of the substrate 181, or within the base 181 and exposed from the upper surface 181u of the base 181.

The first electrode 182 and the second electrode 183 are formed on the upper surface 181u of the substrate 181 with a potential difference, wherein the potential difference ranges between 0.5 voltages and the 3.5 voltages. In an embodiment, the first electrode 182 and the second electrode 183 have different polarities. In other words, the first electrode 182 is positive electrode or negative electrode, and the second electrode 183 is negative electrode or positive electrode. As a result, when a conductive exterior object bridges the first electrode 182 and the second electrode 183, the potential difference between the first electrode 182 and the second electrode 183 changes to generate a variation. For example, the first electrode 182 may be electrically short to the second electrode 183, such that the potential difference approaches zero; under this situation, the potential difference has a larger variation. When the variation of the potential difference detected by the control unit 190 may be larger than or equal to an allowed predetermined value, a protection mode may be started in accordance with a default mode. The conductive exterior object may be a mixture of metal, a metal compound, or a liquid including mineral and/or ion. The variation of the potential difference may range between 2.5 voltages and 5.0 voltages.

In another embodiment, when the conductive exterior object bridges the first electrode 182 and the second electrode 183, the potential difference between the first electrode 182 and the second electrode 183 may be reduced. For example, when the potential difference may be less or equal to than 2.5 voltages, the short phenomenon may be determined. On the other hand, when the short phenomenon occurs, the potential difference may approach zero. When the potential difference detected by the control unit 190 may be larger than the allowed predetermined value, the protection mode may be started in accordance with the default mode. In an embodiment, the default value may be set as 2.5 voltages, that is, when the potential difference may be less than or equal to 2.5 voltages, the short phenomenon is determined, and then the protection mode is started.

In detail, the protection mode includes, but not limiting to, turning off power of the device automatically or recording information of the abnormal signal on a memory (not shown). The information of abnormal signal may be the variation of the potential difference, the number of accumulation times of abnormality occurring, or occurring time, current value, resistance value, voltage value and pressure value every time. Furthermore, if the pressure value is intended to be recorded when the abnormality occurs, the device may further include a manometer for detecting water pressure and/or atmospheric pressure. In addition, the memory may be integrated into the control unit 190, or be independent from the control unit 190, and the control unit 190 may be a DSP (digital signal processor).

As shown in FIG. 2, at least one of the first electrode 182 and the second electrode 183 may be in circular arrangement on the upper surface 181 u of the substrate 181. For example, the first electrode 182 includes a first main electrode 1821 and a plurality of first branch electrodes 1822. The first main electrode 1821 outward extends to an edge of the upper surface 181u of the substrate 181 from a center region of the substrate 181. The first branch electrodes 1822 are concentrically arranged from the first main electrode 1821. In the present embodiment, the substrate 181 may be a circular substrate, and thus the first branch electrodes 1822 extends in semicircle contour. At least two of the first branch electrodes 1822 are concentrical arrangement.

In addition, in the present embodiment, the first electrode 182 may include a plurality of first branch electrodes 1822 and one or more first main electrodes 1821. As shown in FIG. 2, the first electrode 182 includes a plurality of first branch electrode 1822 and one first main electrode 1821. For easily describing, FIG. 2 shows nine first branch electrodes 1822; however, such exemplification is not meant to be for limiting.

Similarly, structures of the second electrode 183 are similar to that of the first electrode 182. The second electrode 183 includes at least one second main electrode 1831 and a plurality of second branch electrodes 1832. The first electrode 182 and the second electrode 183 on the substrate 181 of the sensor 180 are arranged on a relative position at 180 degrees. On other words, the second main electrode 1831 of the second electrode 183 and the first main electrode 1821 of the first electrode 182 are arranged in the same linear direction, and the second branch electrodes 1832 of the second electrode 183 and the first branch electrodes 1822 of the first electrode 182 are staggered arrangement.

In detail, any first branch electrode 1822 may be located between adjacent two second branch electrodes 1832, or any second branch electrode 1832 may be located between adjacent two first branch electrodes 1822. As a result, when the conductive exterior object touches adjacent two first branch electrode 1822 and the second branch electrode 1832, the short phenomenon occurs.

As shown in FIG. 2, an interval H1 between adjacent two the first branch electrode 1822 and the second branch electrode 1832 may range between 0.05 mm and 0.15 mm. Furthermore, adjacent the first branch electrode 1822 and the second branch electrode 1832 are arranged in equal space or non-equal space. In addition, a width of the first main electrode 1821, a width of the first branch electrode 1822, a width of the second main electrode 1831 and a width of the second branch electrode 1832 range between 0.05 mm and 0.15 mm.

In addition, some first branch electrodes 1822 include a plurality of branch electrodes 1822′, and some second branch electrodes 1832 include a plurality of branch electrodes 1832′, wherein the branch electrodes 1822′ and the branch electrodes 1832′ are arranged adjacent to each other and located disposed on the edge of the upper surface 181u of the substrate 181.

Similarly, some first branch electrodes 1822 include one branch electrode 1822′, and some second branch electrodes 1832 include one branch electrode 1832′. The branch electrode 1822′ and the branch electrode 1832′ are arranged adjacent to each other and disposed on the edge of the upper surface 181u of the substrate 181.

In addition, the branch electrode 1822′ and the branch electrode 1832′ are disposed on a first side (for example, upper half portion) of the first main electrode 1821 and the second main electrode 1831 of the substrate 181, and the branch electrode 1822′ and the branch electrode 1832′ are disposed on a second side (for example, lower half portion) of the first main electrode 1821 and the second main electrode 1831 of the substrate 181, wherein the first side is opposite to the second side.

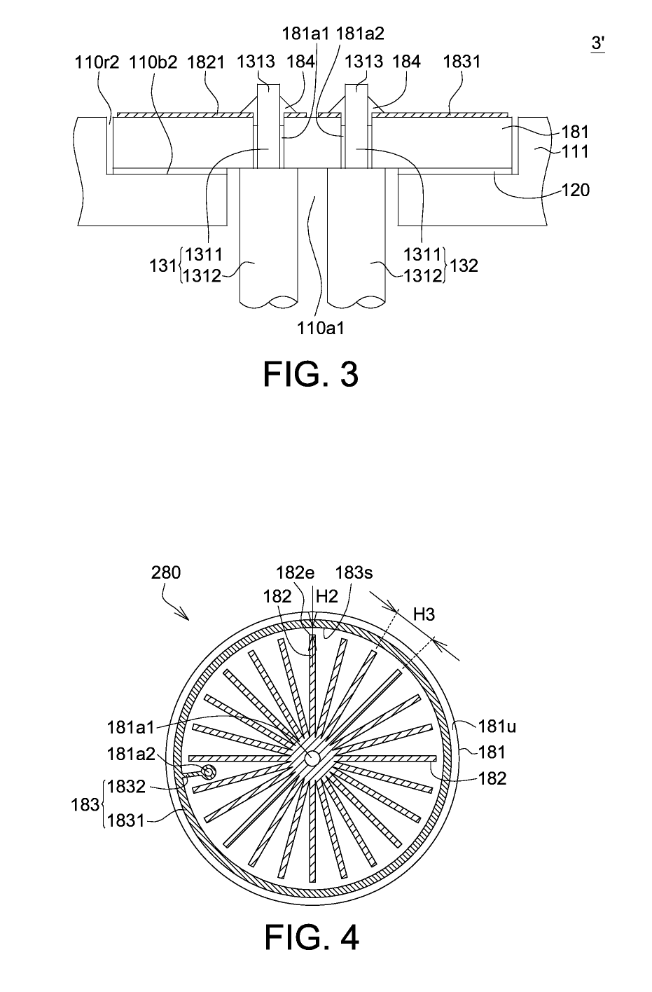

FIG. 3 shows a front view of the bonding layer 120, the first conductive wire 131, the second conductive wire 132, the sensor 180 and the sensor 180 disposing on a local portion of the second accommodating recess 110r2 of the base 110. Each of the first conductive wire 131 and the second conductive wire 132 includes a conductor 1311 and an encapsulating layer 1312, wherein the encapsulating layer 1312 encapsulates the conductor 1311, but exposes an end 1313 of the conductor 1311. The substrate 181 of the sensor 180 includes a plurality of welding points 184, a first through hole 181a1 and a second through hole 181a2, wherein the first through hole 181a1 passes through the substrate 181 and the first electrode 182, and the second through hole 181a2 passes through the substrate 181 and the second electrode 183. In detail, the first through hole 181a1 passes through the substrate 181 and the first main electrode 1821 of the first electrode 182, and the second through hole 181a2 passes through the substrate 181 and the second main electrode 1831 of the second electrode 183; however, such exemplification is not meant to be for limiting. On the other hand, the end 1313 of the first conductive wire 131 passes through the first through hole 181a1 and electrically connected to the first electrode 182 through the corresponding welding point 184, and the end 1313 of the second conductive wire 132 passes through the second through hole 181a2 and electrically connected to the second electrode 183 through the corresponding welding point 184.

As shown in FIG. 3, since the first main electrode 1821 and the second main electrode 1831 extend to the center region of the substrate 181, the first through hole 181a1 and the second through hole 181a2 may pass through the first main electrode 1821 and the second main electrode 1831 in the center region of the substrate 181. As a result, the inner diameter of the first through hole 110a1 may be less, and accordingly the area of the bottom surface 110b2 of the second accommodating recess 110r2 may be larger, such that the sensor 180 may be more stably disposed on the bottom surface 110b2.

FIG. 4 shows a top view of a sensor 280 according to another embodiment of the invention. The sensor 280 incudes the substrate 181, a plurality of the first electrodes 182 and a plurality of the second electrodes 183.

The sensor 280 may be different from the sensor 180 in that each first electrode 182 may be outward and radially extended adjacent to the second electrode 183 from a center of the substrate 181. The second electrode 183 may be a ring-shaped electrode. In the present embodiment, the second electrode 183 may be a closed ring-shaped electrode which disposed on the edge of the upper surface 181u of the substrate 181 and surrounds all first electrodes 182. Due to the design of the closed ring arrangement, the liquid entering the substrate 181 from arbitrary direction have a high probability to touch the first electrode 182 and the second electrode 183. In another embodiment, the second electrode 183 may also be an open ring-shaped electrode.

If the conductive exterior object may be a liquid including mineral and/or ion, the liquid including mineral and/or ion may flow into the periphery of the sensor 180 from other place. Thus, the first electrode 182 may be electrically short to the second electrode 183 through an end surface 182e of the first electrode 182 being adjacent to an inner surface 183s of the second electrode 183. The range of an interval H2 between the end surface 182e of the first electrode 182 and the inner surface 183s of the second electrode 183 approximates the range of the interval H1 of the sensor 180, and the similarities are not repeated.

In addition, a maximum interval H3 between the adjacent two first electrodes 182 may be 5 to 10 times as many as the interval H2, that is, the range may range between 0.25 millimeter (mm) and 1.5 millimeter (mm).

In addition, the second electrode 183 includes a second main electrode 1831 and a second branch electrode 1832, wherein the second main electrode 1831 may be a ring-shaped electrode, and the second branch electrode 1832 inward extends from the second main electrode 1831. The second through hole 181a2 may be disposed on an end portion of the second main electrode 1831 and away from the edge of the upper surface 181u of the substrate 181.

Referring to FIGS. 3 and 4, as a result, the probability of the liquid polluting the welding point 184 and the first conductive wire 131 and/or the second conductive wire 132 may be reduced, and further it prevents from the liquid including mineral and/or ion corroding the welding point 184 and the first conductive wire 131 and/or the second conductive wire 132.

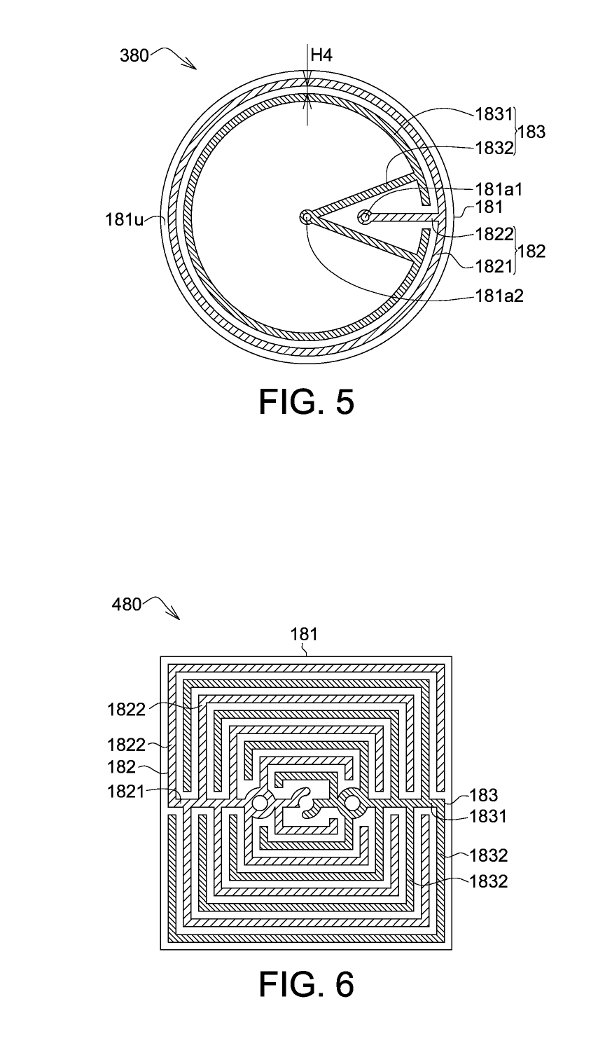

FIG. 5 shows a top view of a sensor 380 according to another embodiment of the invention. The sensor 380 incudes the substrate 181, the first electrodes 182 and the second electrode 183.

The sensor 380 may be different from the sensor 280 in that each of the first electrode 182 and the second electrode 183 includes a ring-shaped electrode which may be a close ring-shaped electrode or an open ring-shaped electrode. In detail, the first electrode 182 includes the first main electrode 1821 and the first branch electrode 1822, wherein the first main electrode 1821 may be a ring-shaped electrode. In the present embodiment, the first main electrode 1821 may be a close ring-shaped electrode, for example. The first branch electrode 1822 inward extends from the first main electrode 1821. The first through hole 181a1 may be disposed on an end portion of the first branch electrode 1822 and thus separated from the edge of the upper surface 181u of the substrate 181 by a distance.

Similarly, the second electrode 183 includes the second main electrode 1831 and the second branch electrode 1832, wherein the second main electrode 1831 is a ring-shaped electrode. In the present embodiment, the second main electrode 1831 may be an open ring-shaped electrode, for example. The second branch electrode 1832 inward and radially extends from the second main electrode 1831. The second through hole 181a2 may be disposed on an end portion of the second branch electrode 1832 and thus separated from the edge of the upper surface 181u of the substrate 181 by a distance.

Referring to FIGS. 3 and 5, in detail, each of the first main electrode 1821 of the first electrode 182 and the second main electrode 1831 of the second electrode 183 may be disposed the edge of the upper surface 181u of the substrate 181. In addition, the range of an interval H4 between the first electrode 182 and the second electrode 183 approximates the range of the interval H1 of the sensor 180.

FIG. 6 shows a top view of a sensor 480 according to another embodiment of the invention. The sensor 480 incudes the substrate 181, the first electrodes 182 and the second electrode 183. In the present embodiment, the substrate 181 may be a rectangular substrate, and the second accommodating recess 110r2 of the base 110 may be a circular accommodating recess or a rectangular accommodating recess matching the rectangular substrate 181. The first electrode 182 and the second electrode 183 are staggered each other, and each of the first electrode 182 and the second electrode 183 concentrically extends in a rectangular contour. For example, the first electrode 182 includes the first main electrode 1821 and a plurality of the first branch electrodes 1822, wherein the first branch electrodes 1822 extends from the first main electrodes 1821. Since the first branch electrodes 1822 concentrically extend in the contour of the substrate 181, the first branch electrodes 1822 concentrically extend in the rectangular contour. Similarly, the second electrode 183 includes the second main electrode 1831 and a plurality of the second branch electrodes 1832, wherein the second branch electrodes 1832 extend from the second main electrode 1831 and concentrically extend in the rectangular contour.

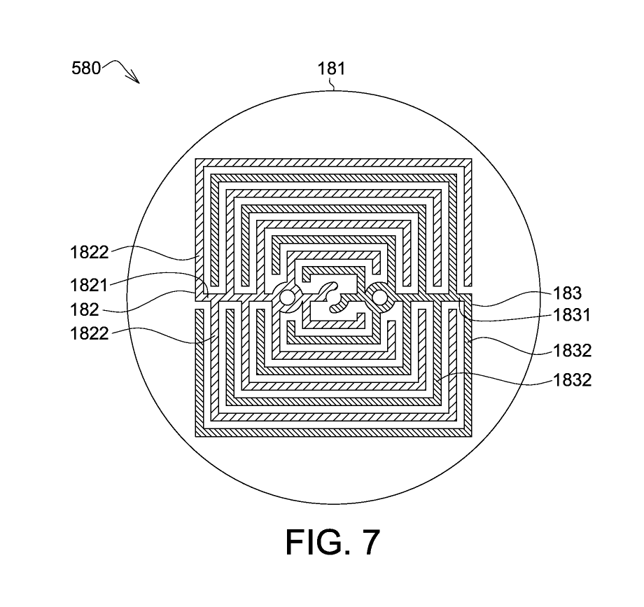

FIG. 7 shows a top view of a sensor 580 according to another embodiment of the invention. The sensor 480 incudes the substrate 181, the first electrodes 182 and the second electrode 183. In the present embodiment, the substrate 181 may be a circular substrate. The extending form of the first electrodes 182 and the second electrode 183 is similar to that of FIG. 6, and the similarities are not repeated.

As described above, only if at least one portion of the first electrode 182 and/or at least one portion of the second electrode 183 are disposed adjacent to each other and disposed on an edge of the upper surface 181u of the substrate 181 for being capable of detecting the conductive exterior object, the pattern, the number and/or size of the first electrode 182 and the second electrode 183 are not limited to the present embodiment.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic transmitting module, comprising:
a base having an accommodating recess;
a sensor disposed within the accommodating recess and comprising a substrate, one or more than one first electrode and one or more than one second electrode, and the first electrode and the second electrode are formed on a surface of the substrate with a potential difference; and
a cover closing or opening the accommodating recess.

2. The electronic transmitting module according to claim 1, wherein the first electrode and the second electrode have different polarities.

3. The electronic transmitting module according to claim 2, wherein the sensor comprises a plurality of the first electrodes in radial arrangement, and the second electrode surrounding the first electrodes.

4. The electronic transmitting module according to claim 2, wherein at least one of the first electrode and the second electrode is in circular arrangement on the surface of the substrate.

5. The electronic transmitting module according to claim 2, wherein the first electrode comprises a plurality of first sub-electrodes, the second electrode comprises a plurality of second sub-electrodes, and the first sub-electrodes and the second sub-electrodes are staggered arrangement.

6. The electronic transmitting module according to claim 5, wherein the first sub-electrodes and the second sub-electrodes are concentrical arrangement.

7. An electronic device, comprising:
an electronic transmitting module according to claim 1; and
a control unit outputting a control signal in accordance with a variation of the potential difference.

8. The electronic device according to claim 7, further comprising a memory, the memory records at least one of the following parameters: an accumulation number, a recorded time, an electric current, a resistance, a voltage and a pressure.

9. An electronic transmitting module, comprising:
a base;
a circuit board; and
a sensor disposed on the base and electrically connected to the circuit board, the sensor comprises a substrate, one or more than one first electrode and one or more than one second electrode, and the first electrode and the second electrode are exposed from the substrate with a potential difference.

10. The electronic transmitting module according to claim 9, wherein the sensor comprises a plurality of the first electrodes in a radial arrangement and the second electrodes surrounding the first electrodes.

11. The electronic transmitting module according to claim 9, wherein the first electrodes and/or the second electrodes are in a ring arrangement.

12. The electronic transmitting module according to claim 9, wherein the first electrodes comprise a plurality of first sub-electrodes, the second electrodes comprise a plurality of second sub-electrodes, and the first sub-electrodes and the second sub-electrodes are staggered arrangement.

13. The electronic transmitting module according to claim 12, wherein the first sub-electrodes and the second sub-electrodes are concentrical arrangement.

14. The electronic transmitting module according to claim 9, wherein the first electrodes and the second electrodes have different polarities.

15. An electronic device, comprising:
an electronic transmitting module according to claim 9; and
a control unit outputting a control signal in accordance with a variation of the potential difference.

16. The electronic device according to claim 15, further comprising a memory, the memory records at least one of the following parameters: an accumulation number, a recorded time, an electric current, a resistance, a voltage and a pressure.

17. An electronic device, comprising:
an electronic transmitting module comprising a base, a circuit board and a sensor, the sensor comprises a substrate, one or more than one first electrode and one or more than one second electrode, the first electrode and the second electrode are exposed from the substrate, and the first electrodes and the second electrodes have a potential difference; and
a control unit outputting a control signal in accordance with a variation of the potential difference.

18. The electronic device according to claim 17, wherein the first electrodes are in a radial arrangement or a ring arrangement.

19. The electronic device according to claim 17, wherein the first electrodes comprise a plurality of first sub-electrodes, the second electrodes comprise a plurality of second sub-electrodes, and the first sub-electrodes and the second sub-electrodes are staggered arrangement.

20. The electronic device according to claim 17, further comprising a memory, the memory records at least one of the following parameters: an accumulation number, a recorded time, an electric current, a resistance, a voltage and a pressure.
